(19) United States
(12) Patent Application Publication
(10) Pub. No.: US 2011/0045687 A1
(43) Pub. Date: Feb. 24, 2011

(54) ELECTRICAL CONNECTOR ASSEMBLY FOR FACILITATING HEAT DISSIPATION

(75) Inventor: FANG-JWU LIAO, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/859,434

(22) Filed: Aug. 19, 2010

(30) Foreign Application Priority Data
Aug. 19, 2009 (TW) 98215233

(51) Int. Cl. H01R 13/00; H01R 13/40

(52) U.S. Cl. 439/487; 439/733.1

(57) ABSTRACT

An electrical connector assembly (100) includes an insulative housing (1), a number of contacts (2) received in the insulative housing, an integrated circuit (IC) package (3) mounted onto the insualtive housing, and a heat sink (4) attached on the IC package. The insulative housing includes a main portion (11) and a number of side walls (12) extending upwardly from the main portion. The IC package includes a base (31) and a die (32) attached to the base. The heat sink is supported by the side walls of the insulative housing and is in contact with the die of the IC package.

### BACKGROUND OF THE INVENTION

1. Field of the Invention

The present invention relates generally to an electrical connector assembly, and more particularly to an electrical connector assembly for facilitating heat dissipation.

2. Description of Related Arts

TW Pat. No. M338467 issued on Aug. 11, 2008 and having the same assignee as the present patent application discloses a traditional electrical connector assembly of an IC package, a CPU connector, and a heat sink. The CPU connector comprises an insulative housing of a generally rectangular shape, a plurality of terminals held within the insulative housing, a stiffener defining an opening for surrounding periphery edges of the insulative housing, a retention structure having a load plate, and a load lever cooperative to forcibly press together the IC package and the insulative housing. The heat sink is attached on the IC package. The IC package comprises a substrate, a die attached to the substrate, and a load distributor frame surrounding the die. The die defines an upper surface and the load distributor frame defines a top surface higher than the upper surface. In assembly, the heat sink is attached on the top surface of the load distributor frame for dissipating heat generated by the die. The load distributor frame can take most of the force from the load plate and the heat sink, and disperse the force to the substrate. The die is prevented from being damaged because the die can avoid taking pressure from the load plate. However, the load distributor frame is still one part of the IC package, and the IC package is actually the undertaker of the pressure. Moreover, heat is mostly generated from the die. Because the die has a distance away from a bottom surface of the heat sink, heat is conducted to the heat sink by virtue of air, which is slow. Accordingly, in such an electrical connector assembly, the heat does not dissipate quickly.

Hence, an electrical connector assembly for facilitating heat dissipation is desired to overcome the aforementioned disadvantage of the prior art.

### SUMMARY OF THE INVENTION

Accordingly, an object of the present invention is to provide an electrical connector assembly for facilitating heat dissipation.

To achieve the above object, an electrical connector assembly includes an insulative housing, a number of contacts received in the insulative housing, an integrated circuit (IC) package mounted onto the insualtive housing, and a heat sink attached on the IC package. The insulative housing includes a main portion and a number of side walls extending upwardly from the main portion. The IC package includes a base and a die attached to the base. The heat sink is supported by the side walls of the insulative housing and is in contact with the die of the IC package.

Other objects, advantages and novel features of the invention will become more apparent from the following detailed description when taken in conjunction with the accompanying drawings.

### BRIEF DESCRIPTION OF THE DRAWINGS

FIG. 1 is a perspective, exploded view of an electrical connector assembly constructed in accordance with the present invention;

FIG. 2 is a side view of the electrical connector assembly when the heat sink does not get to the insulative housing;

FIG. 3 is another side view of the electrical connector assembly when the heat sink gets to the insulative housing;

FIG. 4 is a partly cross-section view of the electrical connector assembly of FIG. 2; and

FIG. 5 is a partly cross-section view of the electrical connector assembly of FIG. 3.

### DETAILED DESCRIPTION OF THE PREFERRED EMBODIMENT

Reference will now be made in detail to the preferred embodiment of the present invention.

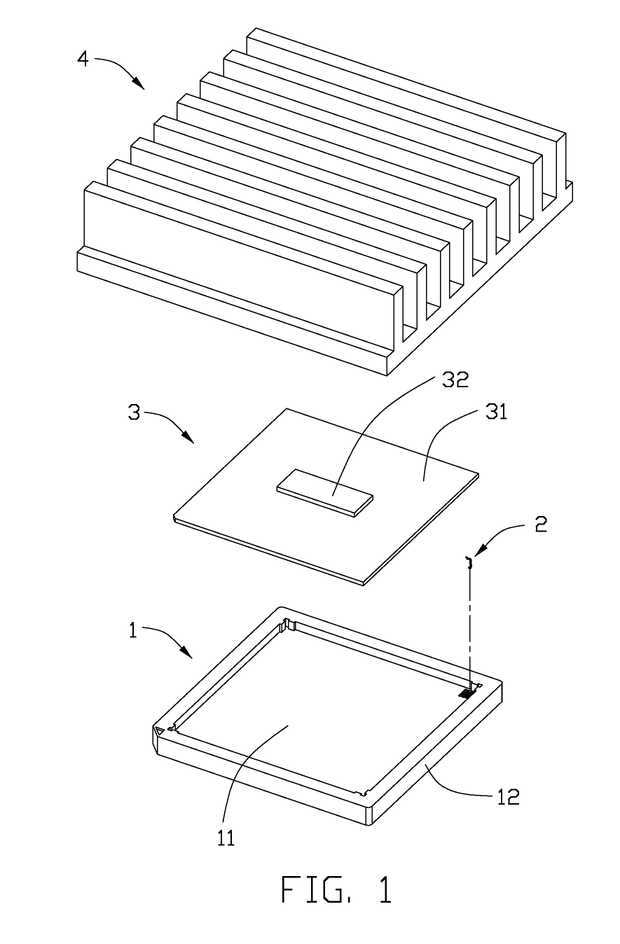

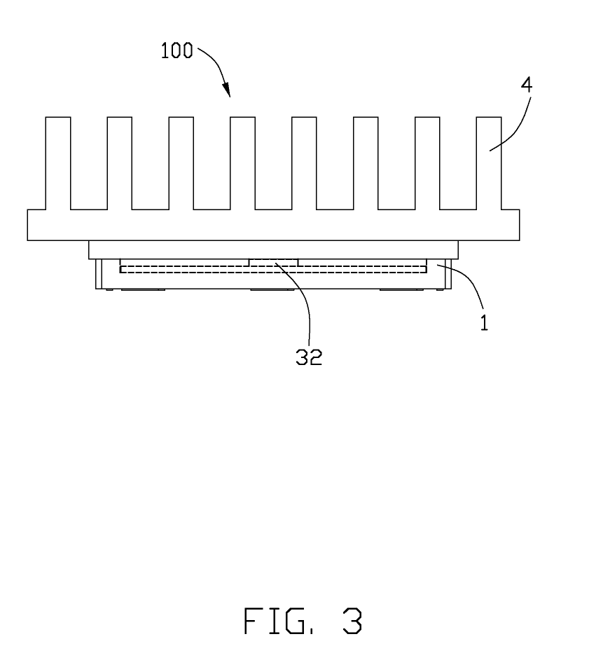

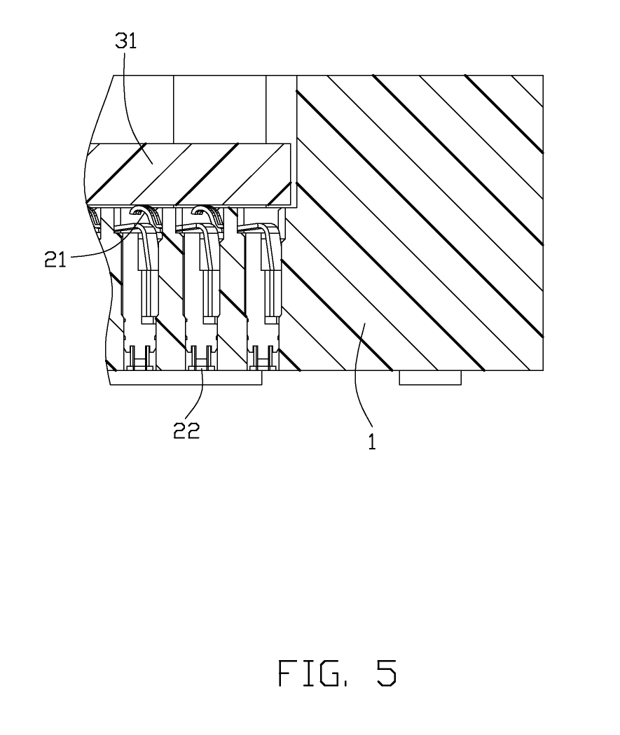

Referring to FIGS. 1-5, an electrical connector assembly 100 comprises an insulative housing 1, a plurality of contacts 2 received in the insulative housing 1, an IC (Integrated Circuit) package 3 installed on the insulative housing 1 and a heat sink attached on the IC package 1.

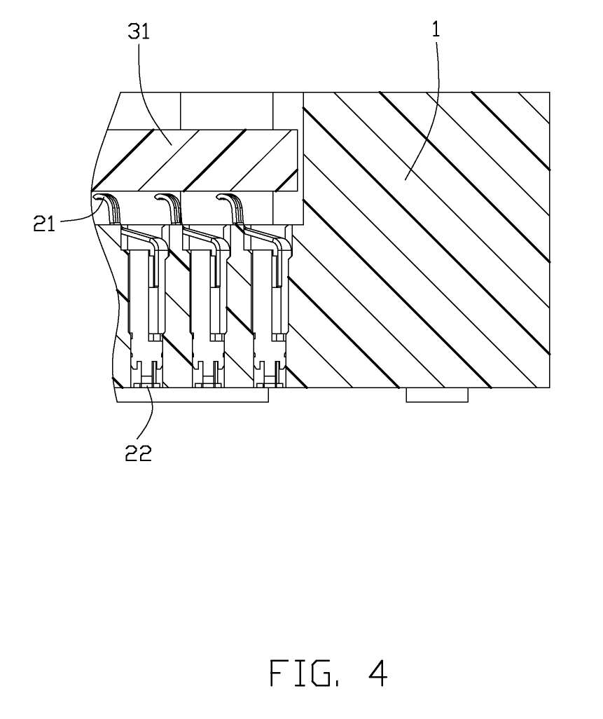

Referring to FIGS. 1 and 4, the insulative housing 1 is generally rectangular shaped and comprises a main portion 11 and a plurality of side walls 12 extending upwards from edges of the main portion 11, both cooperatively defining a receiving room for the IC package 3. The side walls 12 defines an upper surface (not labeled) thereof The contacts 2 are received in the main portion 11 and each comprises a contacting portion 21 extending beyond an upper face of the main portion 11 for connecting with the IC package 3 and a soldering portion 22 extending beneath a lower face of the main portion 11 for connecting with a printed circuit board (PCB).

Referring to FIGS. 1-3, the IC package 3 comprises a base 31 and a die 32 attached to the base 31, generally located at a center of the base 31.

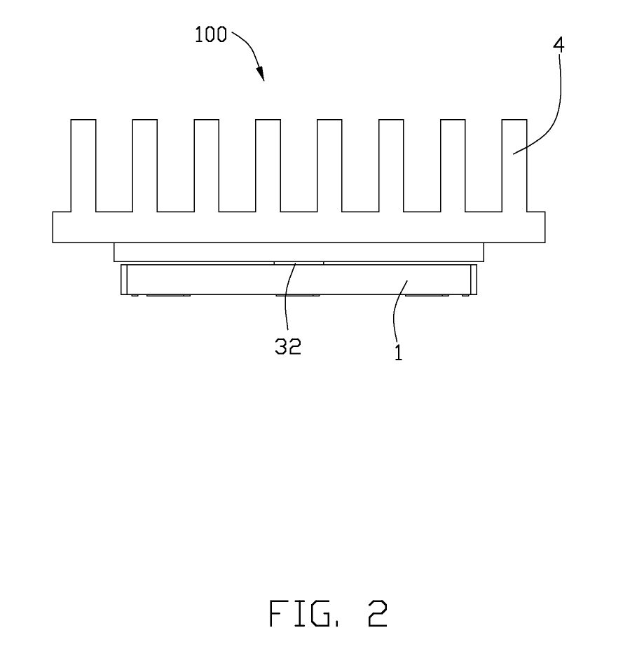

Referring to FIGS. 2-5, when the heat sink 4 is not assembled, the die 32 of the IC package 3 is located higher than the upper surface of the side walls 12, contacts with the contacting portions 21 of the contacts 2 and is supported by the contacts 2 by virtue of elasticity of the contacts 2. When the heat sink 4 is assembled, the heat sink 4 presses against the die 32 of the IC package 3 and drive the IC package 3 to move downwardly. The IC package 3 presses the contacts 2 to entirely be received in the main portion 11 of the insulative housing 1 and is supported by the upper surface of the main portion 11. The die 32 is coplanar with the upper surface of the side walls 12 of the insulative housing 1. Finally, the heat sink 4 is supported by the side walls 12 of the insulative housing 1. The insulative housing 1 undertakes most pressure from the heat sink 4. Therefore, the IC package 3 is prevented from being damaged. Because the die 32 of the IC package 3 connects directly with the heat sink 4, heat timely and effectively dissipates away through the heat sink 4.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector assembly comprising:
an insulative housing comprises a main portion and a plurality of side walls extending upwardly from the main portion;
a plurality of contacts received in the insulative housing;
an integrated circuit (IC) package mounted onto the insualtive housing, the IC package comprising a base and a die attached to the base; and
a heat sink attached on the IC package and supported by the side walls of the insulative housing, the heat sink being in contact with the die of the IC package.

2. The electrical connector assembly as claimed in claim 1, wherein the die is higher than the upper surface of the side walls of the insulative housing when the heat sink is not assembled.

3. The electrical connector assembly as claimed in claim 2, wherein the die is coplanar with the upper surface of the side walls of the insulative housing when the heat sink is assembled.

4. The electrical connector assembly as claimed in claim 1, wherein each contact comprises a contacting portion extending beyond an upper face of the main portion for connecting with the IC package and a soldering portion extending beneath a lower face of the main portion for soldering with a printed circuit board.

5. The electrical connector assembly as claimed in claim 4, wherein the contacts are pressible to be entirely received in the main portion.

6. The electrical connector assembly as claimed in claim 4, wherein the IC package confronts the upper face of the main portion when the heat sink is assembled.

7. An electrical connector assembly comprising:
an insulative housing defining a base with a plurality of side walls upwardly extending therefrom and cooperating with said base to commonly form a receiving space;
a plurality of terminal disposed in the housing, each of said terminals including a contacting section extending upwardly beyond a top face of the base and into the receiving space;
a heat sink seated upon the side walls; and
an electronic package disposed in the receiving space, via upward support of the terminals, with opposite upper and bottom surface thereon, a plurality of pads formed on the bottom surface and mechanically and electrically connected to the contacting section of the corresponding terminals, respectively, wherein
said electronic package includes a die protruding upward beyond the upper surface and contacting a bottom face of the heat sink while the upper surface is spaced from the bottom face of the heat sink with a gap.

8. The electrical connector assembly as claimed in claim 7, wherein the bottom surface of the electronic package is seated upon the the top face of the base.
